(19) United States
(12) Patent Application Publication
(10) Pub. No.: US 2013/0251984 A1
(43) Pub. Date: Sep. 26, 2013

(54) Method for Producing an Insulation Coating on a Grain-Oriented Electrical Steel Flat Product and Electrical Steel Flat Product Coated with Such an Insulation Coating

(71) Applicants: Carsten Schepers, Raesfeld (DE); Chaoyong Wang, Dortmund (DE); Ludger Lahn, Moers (DE); Heiner Schrapers, Duisburg (DE); Stefan Pahlke, Gelsenkirchen (DE)

(72) Inventors: Carsten Schepers, Raesfeld (DE); Chaoyong Wang, Dortmund (DE); Ludger Lahn, Moers (DE); Heiner Schrapers, Duisburg (DE); Stefan Pahlke, Gelsenkirchen (DE)

(73) Assignee: THYSSENKRUPP ELECTRICAL STEEL GMBH, Gelsenkirchen (DE)

(21) Appl. No.: 13/878,075

(22) PCT Filed: Sep. 22, 2011
(86) PCT No.: PCT/EP11/66509

§ 371 Date: Jun. 6, 2013

(30) Foreign Application Priority Data
Oct. 7, 2010 (DE) 102010038038.5

(51) Int. Cl. H01B 3/02

(52) U.S. Cl. CPC H01B 3/025
USPC 428/336; 427/372.2

(57) ABSTRACT

The invention relates to a method for producing a grain-oriented electrical steel flat product with minimised magnetic loss values wherein the method comprises the following work steps:
a) providing an electrical steel flat product,
b) applying a layer of a phosphatic insulation solution for at least one surface of the electrical steel flat product and baking the applied layer.

In order that the tensile stresses acting on the surface of an electrical steel flat product are increased further by means of such a method, the invention proposes that, after a first execution of work step b) this work step b) is repeated at least once, so that from the layers of phosphatic insulation solution applied and baked one after another and one on top of the other an insulation coating is obtained.

The invention concerns a method for producing a grain-oriented electrical steel flat product with minimised magnetic loss values.

The invention also concerns a grain-oriented electrical steel flat product that is provided with an insulation coating.

The grain-oriented electrical steel flat products referred to here are steel strips or sheets, from which parts are made for electrotechnical applications. Such grain-oriented electrical steel flat products are suited in particular for applications in which a particularly low hysteresis loss is paramount and high demands are made regarding permeability or polarisation. These requirements exist in particular in the case of parts for power transformers, distribution transformers and high-quality small transformers.

As explained in detail for example in EP 1025268 B1, in general in the course of manufacture of electrical steel flat products initially a steel, which typically contains (in Wt %) 2.5 to 4.0% Si, 0.010 to 0.100% C, up to 0.150% Mn, up to 0.065% AI and up to 0.0150% N, and in each case optionally 0.010 to 0.3% Cu, up to 0.060% S, up to 0.100% P, up to in each case 0.2% As, Sn, Sb, Te and Bi, the remainder iron and unavoidable impurities, is cast to provide a starting material, such as a slab, a thin slab or a cast strip. The starting material then undergoes annealing if necessary, in order then to be hot-rolled into a hot strip.

After coiling or an optional further annealing and similarly completion of optional descaling or pickling treatment, the hot strip is then rolled in one or more steps into a cold strip, wherein between the cold rolling steps if necessary intermediate annealing can be carried out. During the decarbonisation annealing that is subsequently carried out the carbon content of the cold strip is normally reduced considerably in order to avoid magnetic ageing.

After the decarbonisation annealing an annealing separator, typically MgO, is applied to the strip surfaces. The annealing separator prevents the windings of a coil wound from the cold strip from welding to one another during the high-temperature annealing that is subsequently carried out. During the high-temperature annealing, which is typically performed in a bell furnace under protective gas, the texture arises in the cold strip through selective grain growth. A forsterite layer also forms on the surfaces of the strip, the so-called “glass film”. Additionally, through the diffusion processes occurring during the high-temperature annealing the steel material is cleansed.

After the high-temperature annealing the electrical steel flat product obtained in this way is provided with an insulation coating, thermally straightened and in a subsequent “final annealing” stress-relief annealed. This final annealing can take place before or after preparation of the flat steel produced in the manner described above in the sections necessary for further processing, wherein through final annealing after partitioning of the sections the additional stresses that have resulted from the partitioning can be relieved. Electrical steel flat products created in this way as a rule have a thickness of between 0.15 mm and 0.5 mm.

The metallurgical properties of the material, the degrees of deformation set in the cold rolling processes for production of the electrical steel flat products and the parameters of the thermal treatment steps are in each case matched to one another such that the desired recrystallisation processes take place. These recrystallisation processes result in the “goss-texture” typical for this material, in which the direction of the easiest magnetisation is in the direction of rolling of the finished strips. Grain-oriented electrical steel flat products accordingly have a highly anisotropic magnetic behaviour.

Apart from energy losses, in transformers the noise generated also has a role to play. This is due to a physical effect known as magnetostriction and is influenced inter alia by the properties of the electric steel core material used.

It is known that the insulation coating applied to an electrical steel flat product has a positive effect on minimisation of the hysteresis losses. Thus the insulation coating can transfer tensile stresses to the base material, which not only improve the magnetic loss values of the electrical steel flat product but also reduce the magnetostriction, which in turn has a positive effect on the noise behaviour of the finished transformer.

An insulation coating demonstrating these effects and a method for its production are described, by way of example, in DE 2247269 C3. The main components of the insulation solution used according to the prior art to produce the insulation coating are aluminium phosphate and silicon dioxide, wherein the latter can also be added in colloidal form. A further component of insulation coatings is often chromic acid anhydride (chromium trioxide) or chromic acid, wherein the content of this component which raises concerns due to its effect on the environment can be minimised by a suitable choice of the other contents of the insulation solution (DE 10 2008 008781 A1, EP 2 022874 A1).

Common to the known insulation coatings mentioned above is the fact that initially they are applied to the surface of the electrical steel flat product to be coated which has optionally already been coated with a glass film, the thickness of the insulation coating is then for example adjusted using squeeze rollers and finally the insulation coating is baked in an oven. Here the baking temperature is typically approximately 850° C.

The insulation coating produced in this way following baking exerts a considerable tensile stress on the base material. EP 2022874 A1 gives values thereof of up to 0.8 kg/mm² corresponding to a tensile stress of approximately 8 MPa. According to the further configurations contained in DE 2247269 C3 this effect is due to the differing coefficients of thermal expansion of the insulation coating and base material. According to DE 2247269 C3 layer densities of up to 4 g/m² are achieved here.

The demands that are made concerning minimisation of the noise generated during operation of transformers are constantly increasing. This is due on the one hand to ever-more stringent legal requirements and standards and on the other to the fact that consumers nowadays as a rule will no longer accept electrical equipment which produces an audible “transformer hum”. Thus acceptance of large transformers in the vicinity of residential buildings is crucially dependent upon the noise emissions generated by the operation of such transformers.

Practical experience shows that with conventional electrical steel flat products manufactured according to the prior art the ever-increasing requirements cannot always be readily met. This is because the considerably higher tensile stress transferred necessary to meet these requirements cannot be achieved by simply modifying the coating process. Thus it transpires that an increase in the thickness of the insulation coating does not meet this aim, since during baking increased gases occur, which have an adverse effect on the morphology of the finished layer. Thus in the case of an insulation coating that is too thick, pores result which in the extreme case cause the coating to flake because the cohesion is absent. The problems that arise with insulation coatings of higher thicknesses are also demonstrated by the fact that despite an increase coating thickness, determined by considering a metallographic section under a raster electronic microscope (REM) and given in “μm”, the coating density achieved, given as g/m and which is determined by means of the difference in weight following selective removal of the insulation coating, has a disproportionately lower increase.

Against this background, the object for the invention was to present a method which can be implemented in practice with simple means, with which the tensile stresses acting on the surface of an electrical steel flat product can be increased further. In addition, an electrical steel flat product should be indicated having optimal magnetic properties and in practical use a similarly optimised noise behaviour.

With regard to the method, this object is achieved in that the work steps indicated in claim 1 are performed during the production of an electrical steel flat product.

With regard to the electrical steel flat product the solution according to the invention to the object set out above comprises a flat product having the features indicated in claim 13.

Advantageous embodiments of the invention are indicated in the dependent claims and will be explained in detail in the following together with the basic idea of the invention.

With the method according to the invention for producing a grain-oriented electrical steel flat product with minimised magnetic loss values according to the prior art set out above the following work steps a) and b) are performed:

### Work Step a)

Providing an electrical steel flat product.

There are no special requirements for the way in which the electrical steel flat product provided is produced. Thus the electrical steel flat product provided for the method according to the invention can be produced by application of the guidelines given to a person skilled in the art in the publications already mentioned above on the basis of steel alloys. This obviously also includes production processes which are currently not yet known, but in which as with the prior art the application and baking of an insulation coating is provided for.

### Work Step b)

Applying a layer of phosphatic insulation solution to at least one surface of the electrical steel flat product and baking the applied layer.

The manner of application, the setting of the layer thickness, the composition of the insulation solution and the manner of the baking of the insulation coating formed by the insulation solution can similarly reflect the prior art.

According to the invention, now, after a first execution of work step b) this work step b) is repeated at least once, so that as a result, from the layers of phosphatic insulation solution applied and baked one after another and one on top of the other an insulation coating is obtained.

According to the invention therefore an increased layer thickness of the insulation coating is produced in that at least two separate coating steps are carried out, wherein initially the first insulation coating layer is finish-baked, and then at least one further insulation coating layer is likewise applied and baked. If necessary the coating and baking process can be repeated a number of times more, in order that through the application and baking of further layers of insulation solution an even greater coating thickness is produced. Practical trials have shown, however, that even with just one repetition of the process sequence making up work step b) here of “application of the coating” and “baking of the respective layer of insulation solution applied” a considerable increase in the tensile stresses transferred to the steel substrate of an electrical steel flat product according to the invention is achieved.

According to the invention the insulation coating is thus formed by at least two layers of a phosphatic insulation means, which are individually applied and baked. Together the insulation coatings then form an insulation coating, which is characterised by a high specific coating density and a high thickness.

Because the insulation coating according to the invention is produced in separate work steps for each coating of insulation solution applied and baked, the unfavourable development of the specific coating density in relation to the coating thickness which occurs if a thick insulation coating is applied in a single operation is avoided. With the invention such high coating thicknesses can be produced with very high specific coating densities. This is reflected in the tensile stresses, magnetic loss values or apparent powers and magnetostriction values achieved and in the emitted noise levels (LvA value=A-weighted magnetostriction velocity level; LaA-value=A-weighted magnetostriction acceleration level). Consequently from electrical steel flat products produced according to the invention, in particular plates for transformers can be produced, with which during operation the noise emissions are considerably reduced compared with transformers made from conventional magnetic steel sheets.

The phosphatic insulation solution used for producing the insulation coating in work step b), in the manner of the insulation solutions already tried and tested in the prior art for this purpose, can comprise a colloidal component, which may in particular be a colloidal silicon dioxide.

Basically an insulation solution used according to the invention for producing the insulation coating can contain the most varied of phosphates. Particularly good results are obtained, however, with a phosphatic insulation solution containing aluminium and/or magnesium phosphate. Water is preferably used as the basis for the phosphate solution. Of course, other solvents can also be used, however, provided that they have a reactivity and a polarity similar to water.

According to a preferred embodiment of the invention the insulation solution also contains at least one additive, selected from a group comprising pickling inhibitors and wetting agents. Through the use of pickling inhibitors and/or wetting agents the properties of the grain-oriented electrical steel flat product produced with the method according to the invention can be further improved.

Because the insulation solution used to produce the insulation coating according to the invention contains a colloid stabiliser as an additive, in a known manner it is possible to guarantee that the transition from sol to gel only takes place when the phosphate coating is drying. Furthermore, the use of colloid stabilisers allows a homogenous application of the phosphate solution so that consistent quality of the finished coatings can be achieved.

More detailed explanations on the possible composition of an insulation solution, which can be considered for the production according to the invention of an insulation coating on an electrical steel flat product, can be found, for example, in DE 10 2008 008781 AI.

Depending on the production conditions and the properties sought it may be expedient, in the at least one repetition of work step b) to use an insulation solution that has been modified compared with the insulation solution used in the first execution of work step b). Practical trials have demonstrated, however, that a particularly good adhesion and a particularly high specific coating density r of the insulation coating applied in at least two layers result if in the first and each subsequent execution of work step b) insulation solutions with identical compositions are used.

It is important for the invention that the layer of insulation coating applied and baked in each preceding work step b) is fully baked before the next layer of insulation solution is applied in a repetition of work step b). This requires that during the baking treatment a temperature level is achieved which is greater than that for simple drying. Accordingly, the invention provides for a practical implementation whereby the baking temperature of the baking performed in the course of work step b) is at least 300° C.

For economical reasons, it is particularly advantageous if at least during the baking that takes place in the course of the final repetition of work step b) the baking temperature is at least 700° C. At this temperature level the baking treatment can be combined with stress relief annealing, in order to relieve the unavoidable stresses that usually build up as a result of the method. The annealing can take place in a continuous furnace under air as short-time annealing or in a muffle furnace (long-time annealing) under nitrogen, wherein in combination with the baking treatment the short-time annealing has proven particularly advantageous with regard to the formation of a high specific coating density and optimum adhesion of the insulation coating produced according to the invention. The baking result is ensured in particular in combination with the relief of any stresses that may still be present, if the baking temperature is at least 800° C., in particular approximately 850° C. In order to avoid undesired changes in the structure of the steel substrate of the electrical steel flat product processed according to the invention, at the same time in the baking performed in the course of work step b) the baking temperature should in each case not exceed 900° C. and in particular should be kept below 900° C.

In principle, of course, it is conceivable in each case to use the same unit for each repetition of work step b). The method according to the invention can be performed particularly economically, however, if the repeated execution of work step b) follows a treatment line, in which in the line a number of devices for applying and baking the insulation solution, corresponding to the number of repetitions, are arranged one after another and are passed by the electrical steel flat product to be coated in a continuous process. If, for example, the insulation coating is to formed of two layers of insulation solution applied and baked one after another in a manner according to the invention, then in such a line therefore during continuous operation a first device for applying and baking the first layer of insulation coating and a second device for applying and baking the second layer will be passed through in succession.

With electrical steel flat products produced and provided according to the invention the ratio of coating thickness to specific coating density and the ratio of coating thickness to tensile stress is in each case in an optimum range. As practical trials have shown, these ranges are more favourable in practical application than the ranges for the characteristics concerned when a correspondingly thick insulation coating is applied and baked in a single process.

A grain-oriented electrical steel flat product provided according to the invention, having on at least one of its surfaces a baked phosphatic insulation coating, is accordingly characterised in that where the thickness D of the phosphatic insulation coating is ≦3 μm, the specific coating density r of the phosphatic insulation coating is ≧5 g/m², whereas for a thickness D>3 μm for the specific coating density r of the phosphatic insulation coating the following applies:

r [g/m²]>3/5 g/μm/m²*D [μm].

Here, in the event that the specific coating density r of the phosphatic insulation coating is ≧5.0 g/m², a tensile stress Z transferred by the insulation coating, satisfies the following condition:

Z [MPa]>7/6 MPa*m²/g*r [g/m²].

Electrical steel flat products provided in the manner indicated above can be produced economically, reliably and in an operationally safe manner by application of the method according to the invention.

The invention is explained in more detail in the following using exemplary embodiments and comparative. These show as follows:

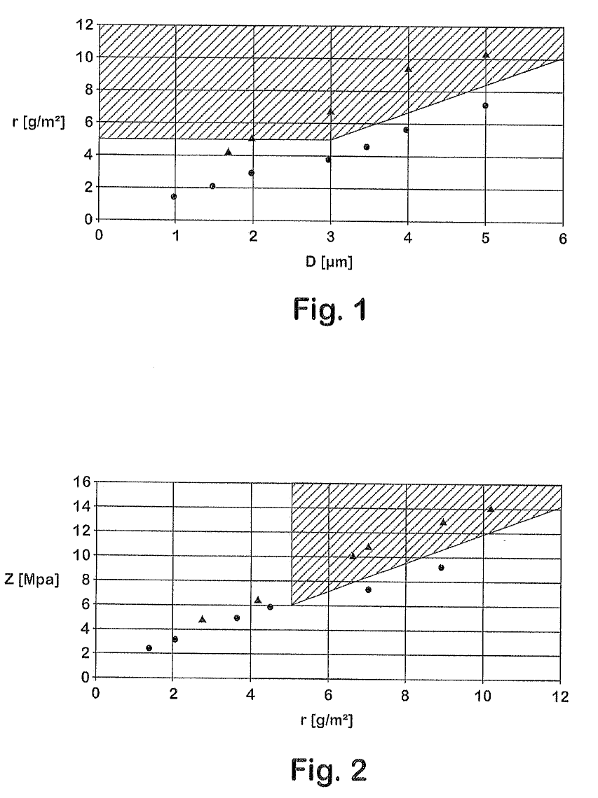

FIG. 1: a diagram plotting the specific coating density r given in g/m² against the thickness D given in μm of the respective insulation coating for various specimens coated twice according to the invention and once according to the conventional method.

FIG. 2: a diagram plotting the tensile stresses exerted by the respective insulation coating on the steel substrate of the electrical flat steel product, given in MPa, against the specific density r in g/m² of the respective insulation coating for various specimens coated twice according to the invention and once according to the conventional method

In the diagram shown in FIG. 1 the specific density values r determined for the specimens coated twice according to the invention are shown against the respective thickness D of the insulation coating by solid triangles, while the specific density values r determined for the conventional specimens against the assigned thickness D of the insulation coating are shown by solid circles.

It can be seen that the specimens coated according to the invention at coating thicknesses of at least 3 μm regularly have coating densities r which satisfy the condition r [g/m²]>3/5 g/μm/m²*D [μm]. With insulation coatings lower than 3 μm thick, a specific density r resulted, which in each case is greater than 4 g/m², wherein in relation to the properties sought according to the invention the limit of the specific coating density for the insulation coatings of less than 3 μm thick, still meeting the requirements according to the invention has been set at 5 g/m². With the results shown in FIG. 1 this requirement is met by specimens whose insulation coating thickness D is at least 2 μm.

As with the diagram shown in FIG. 1, in the diagram shown in FIG. 2 the tensile forces Z determined for the specimens coated twice according to the invention against the respective specific coating density r are indicated by solid triangles, while the tensile stresses Z determined for the conventional specimens against the assigned specific layer density r of the insulation coating are symbolised by solid circles.

It can be seen that with the specimens coated twice according to the invention the insulation coating always exerts higher tensile stresses Z on the steel substrate of the respective electrical steel flat product than with specimens coated in a conventional manner in one operation with a single insulation coating of the same specific coating density r. This is particularly evident for the specimens where the specific coating density r is at least 5.1 g/m². The requirements that arise in practice are accordingly met in particular by such electrical steel flat products according to the invention for which Z [MPa]>7/6 MPa*m²/g*r[g/m²] applies.

In order to demonstrate the effects achieved by the invention ten trials V1-V10 were performed, of which trials V1, V2, V4, V7 and V9 were attributed to the prior art and trials V3, V5, V6, V8 and V10 according to the invention.

In all the trials in each case a section of sheet of 350 mm×60 mm and a nominal thickness of 0.30 mm in grain-oriented electrical steel, from the conventional production of the applicant, was used in the condition following high-temperature annealing. Here the steel strip contained in the decarburised state, in addition to iron and unavoidable impurities (in Wt. %) C: <0.0025%, Si: 3.15%, Mn: 0.08%, S: 0.02%, Cu: 0.07%, Sn: 0.08% and Al: 0.03. As hot strip the steel strip contained 0.06 Wt. % C in the non-decarburised original state.

The specimens were cleaned and coated on both sides with an insulation solution in a coating system. The coating system had twin squeeze roller pairs for setting the desired coating thickness. By adjusting the clearance of the squeeze rollers from the surface of the specimens assigned to them the respective desired thickness could be set.

The aqueous insulation solutions used in the trials contained the following components, per litre, wherein the grams amounts are given as absolute values and the respective concentrations in “( )”:

### Trials V1-V6

150 g mono aluminium phosphate (50%)
183 g colloidal silicon dioxide (30%)
12 g chromium trioxide

### Trials V7, V8

150 g mono aluminium phosphate (50%)
183 g colloidal silicon dioxide (30%)
2 g pickling inhibitor with diethylthiourea as active substance
10 g colloid stabiliser with triethylphosphate as active substance

### Trials V9, V10

150 g mono aluminium phosphate (50%)
183 g colloidal silicon dioxide (30%)
2 g pickling inhibitor with diethylthiourea as active substance
10 g colloid stabiliser with triethylphosphate as active substance
36 g chromium (III) nitrate, nonahydrate

Table 1 shows for trials V1-V10, in each case the thickness D of the insulation coating created, the specific coating density r of the insulation coating, the hysteresis loss P_{1, 7/50} at a frequency of 50 Hertz and a polarisation of 1.7 Tesla, the apparent power S_{1, 7/50} at a frequency of 50 Hertz and a polarisation of 1.7 Tesla, the Lv_{A} value, the La_{A} value and the tensile stress exerted by the respective insulation coating on the steel substrate of the respective specimen.

The respective thickness D of the insulation coating was determined by investigating a microsection of the respective specimen under the raster electron microscope.

The specific coating density r of the insulation coating was determined by removing the phosphate coating with sodium hydroxide (25%) at 60° C.

The tensile stress exerted by the insulation coating in each case was determined by determining the difference in curvature of the respective specimen before and after single-side removal of the insulation coating.

### Trial VI (not According to the Invention)

The specimen was coated on both sides with the insulation solution. In so doing, by corresponding adjustment of the squeeze rollers the small layer thickness indicated given in Table 1 was set.

Immediately after application of the insulation coating the coating was baked for 1 minute at 840° C. under a nitrogen atmosphere.

The tensile stress of the insulation was determined in the following way:

One side of the specimen was masked with pickling-resistant film. The specimen was placed in sodium hydroxide (60%) at 60° C. for 10 minutes. The previously applied and baked phosphatic insulation coating on the unprotected side was in this way removed, without the glass film/forsterite beneath being attacked.

The curvatures of the specimen were determined before and after this treatment and from the difference thereof the tensile stress transferred by the insulation coating was determined.

From the difference in weight of the specimen before and after removal of the insulation coating it was also possible to determine the specific coating density r.

### Trial V2 (not According to the Invention)

The squeeze rollers were opened to wider than in Trial VI, so that upon application of the insulation solution a somewhat larger coating thickness was set, as is normal in industrial production.

Immediately after application the coating was baked for 1 minute at 840° C. in nitrogen atmosphere.

The specific coating density determined for this specimen corresponded approximately to that of normal production practice.

### Trial V3 (According to the Invention)

The squeeze rollers of the coating system were set at a lower contact pressure than in Trial Vi, in order to achieve a greater thickness of the layer of insulation solution applied in each case.

Immediately after application the layer applied was again baked for 1 minute at 840° C. under a nitrogen atmosphere.

The coating process was then repeated. To do this the specimen was again passed through the coating system in the same way as the first time, in order to apply a second layer of insulation solution to the previously baked layer. Again, immediately after this second application the coating was baked for 1 minute at 840° C. under a nitrogen atmosphere.

The magnetic characteristic values determined for the specimen processed in Trial V3 and the magnetostriction with the LvA and LaA values, were, in spite of a lower thickness, much higher than the specimen processed in Trial V2.

The same applies to the tensile stress Z applied by the insulation coating. Despite a significantly lower thickness D of the insulation coating, this was also considerably above the values determined for Trial V2.

### Trial V4 (not According to the Invention)

The squeeze rollers of the coating system were adjusted so that a thicker coating than normally produced was achieved. Immediately after application the coating was baked for 1 minute at 840° C. in a nitrogen atmosphere.

Despite the considerably thicker coating, the tensile stress exerted on the steel substrate of the specimen by an insulation coating created in a single coat, at 7.5 MPa, was significantly below the tensile stress exerted by the insulation coating produced in Trial V3 according to the invention.

### Trial V5 (According to the Invention)

The squeeze rollers of the coating system were adjusted more narrowly than in Trial V4. Immediately after application the layer of insulation solution obtained was baked for 1 minute at 840° C. in a nitrogen atmosphere.

Then the coating process was repeated. To do this the specimen was for a second time passed through the coating system in the same way as the first time, in order to apply a second layer of insulation solution to the previously baked layer. Again, immediately after this second application the coating was baked for 1 minute at 840° C. under a nitrogen atmosphere.

The magnetic characteristic values including the magnetostriction with the LvA and LaA values were considerably better than for the specimen produced in Trial V4 despite the thickness being the same.

The tensile stress exerted by the insulation coating on the steel substrate of the specimen produced a very good value of 14.0 MPa. It was therefore considerably better than the tensile stress exerted by the specimen produced in Trial V4.

The specific coating density r of the specimen coated twice here according to the invention, was, in spite of the coating thickness D being the same, considerably higher than for the specimen produced in Trial V4.

### Trial V6 (According to the Invention)

The squeeze rollers were set in the same way as for Trial V5. Immediately after application the coating was baked for 10 seconds at 300° C. in a nitrogen atmosphere.

The specimen was passed a further time through the coating system with the squeeze rollers at the same setting. Immediately thereafter a further baking treatment was carried out under a nitrogen atmosphere, wherein in this case the baking time was 1 minute and the baking temperature 840° C.

The properties of the specimen processed in this way are approximately the same as those of the specimen processed according to Trial V5.

The tensile stress transferred by the insulation coating to the steel substrate provided a value of 12.5 MPa. Thus it was similarly as high as for the specimen produced according to Trial V5.

So the baking of the first layer formed by the insulation solution is also possible at lower temperatures. However, the baking of the repeat application and baking of an insulation should take place at a higher temperature, in order to be able to make use of the difference in thermal coefficients of expansion to generate the tensile stress.

The advantage of such an approach, in which the first layer of the insulation coating is baked at a low temperature, is that that ovens with a lower baking temperature and shorter baking time can be integrated more easily into existing operational continuous annealing systems and in this way the entire coating process can in principle be performed in a single line.

### Trial V7 (not According to the Invention)

In order to determine the properties of a specimen coated in a conventional manner with a Cr-free insulation solution, but one which contains a colloid stabiliser, the squeeze rollers were set in a similar manner to Trial V2. Immediately after application the coating was baked for 1 minute at 840° C. under a nitrogen atmosphere and the properties, indicated in Table 1, of the specimen obtained after a single coating were determined.

### Trial V8 (According to the Invention)

The squeeze rollers were set in a similar manner to Trial V5. Immediately after the application the coating was baked for 1 minute at 840° C. under a nitrogen atmosphere.

Then the coating process was repeated. To do this the specimen was passed through the coating system a second time in the same way as the first, in order to apply a second layer of insulation solution to the previously baked layer. Again, immediately after this second application the coating was baked for 1 minute at 840° C. under a nitrogen atmosphere.

Then the properties, indicated in Table 1, of the specimen, obtained in this way after a second coating and baking treatment were carried out, were determined. Here also a clear superiority of the specimen coated with the insulation coating in two operations according to the invention is evident.

### Trial V9 (not According to the Invention)

To determine the properties of a specimen, coated in the conventional manner with an insulation solution containing Cr and a colloid stabiliser, the squeeze rollers were set in the same way as Trial V2. Immediately after application here the insulation coating was also baked for 1 minute at 840° C. under a nitrogen atmosphere. The properties of the specimen produced in this way are similarly given in Table 1.

### Trial V10 (According to the Invention)

The squeeze rollers were set in the same was as in Trial V5. Immediately after application the coating was baked for 1 minute at 840° C. under a nitrogen atmosphere.

Then the coating process was repeated. To do this the specimen was passed through the coating system a second time in the same way as the first, in order to apply a second layer of insulation solution to the previously baked layer. Again, immediately after this second application the coating was baked for 1 minute at 840° C. under a nitrogen atmosphere.

Then the properties, indicated in Table 1, of the specimen obtained in this way were determined. Here also a clear superiority of the specimen coated with the insulation coating in two operations according to the invention is evident.

TABLE 1

| | | Spec. | | | | | |
|---|---|---|---|---|---|---|---|
| | Thickness | coating | | | | | Tensile |
| | D | density r | P_{1,7/50} | S_{1,7/50} | Lv_{A 1,7/50} | La_{A 1,7/50} | stress Z |
| V | [μm] | [g/m²] | [W/kg] | [VA/kg] | [dB] | [dB] | [MPa] |
| 1 | 1.5 | 2.1 | 1.070 | 1.327 | 54.2 | 46.1 | 3.2 |
| 2 | 3.5 | 4.5 | 1.040 | 1.245 | 53.0 | 45.0 | 5.9 |
| 3 | 3.0 | 6.7 | 0.979 | 1.190 | 51.2 | 42.4 | 10.1 |
| 4 | 5.0 | 7.1 | 1.029 | 1.239 | 51.4 | 44.9 | 7.5 |
| 5 | 5.0 | 10.2 | 0.925 | 1.177 | 49.1 | 41.0 | 14.0 |
| 6 | 4.8 | 9.9 | 0.937 | 1.184 | 50.9 | 42.1 | 12.5 |
| 7 | 2.5 | 2.8 | 1.062 | 1.303 | 55.0 | 46.7 | 3.3 |
| 8 | 5.0 | 5.5 | 1.030 | 1.241 | 53.7 | 45.5 | 6.5 |
| 9 | 3.1 | 4.4 | 1.048 | 1.296 | 52.6 | 45.2 | 6.0 |
| 10 | 5.2 | 10.7 | 0.929 | 1.167 | 49.5 | 41.2 | 13.9 |

1. A method for producing a grain-oriented electrical steel flat product with minimised magnetic loss values, comprising the work steps:
a) providing an electrical steel flat product, and
b) applying a layer of a phosphatic insulation solution to at least one surface of the electrical steel flat product and baking the applied layer,
wherein after a first execution of work step b) this work step b), is repeated at least once, and the layers of phosphatic insulation solution applied and baked one after another and one on top of the other comprise an insulation coating.

2. The method according to claim 1, wherein the phosphatic insulation solution applied in the respective work step b) comprises a colloidal component.

3. The method according to claim 2, wherein the colloidal component is a colloidal silicon dioxide.

4. The method according to claim 1, wherein the insulation solution contains aluminium phosphate, magnesium phosphate, or both.

5. The method according to claim 1, wherein the insulation solution contains at least one pickling inhibitor and at least one wetting agent.

6. The method according to claim 1, wherein the insulation solution contains at least one colloid stabiliser (A) as an additive.

7. The method according to claim 1, wherein during the baking carried out in the course of work step b), the baking temperature is at least 300° C.

8. The method according to claim 1, wherein during the baking carried out in the course of the final repetition of work step b), the baking temperature is at least 700° C.

9. The method according to claim 1, wherein during the baking carried out in the course of work step b), the baking temperature is in each case a maximum of 900° C.

10. The method according to claim 1, wherein the repeated execution of work step b) is carried out in a treatment line, wherein in a line a number of devices for applying and baking the insulation solution, corresponding to the number of repetitions, are arranged one after another and are passed by the electrical steel flat product to be coated in a continuous process.

11. The method according to claim 1, wherein when the phosphatic insulation coating on the finished electrical steel flat product has a thickness D of up to 3 μm, a specific coating density r of this phosphatic insulation coating is ≧5 g/m², and when the thickness D is more than 3 μm, the following applies for the specific coating density r of the phosphatic insulation coating:
r [g/m²]>3/5 g/μm/m²*D [μm].

12. The method according to 11, wherein when the specific coating density r of the phosphatic insulation coating present on the finished electrical steel flat product is ≧5.0 g/m², the following applies for a tensile stress Z transferred by the insulation coating:
Z [MPa]>7/6 MPa*m²/g*r [g/m²].

13. A grain-oriented electrical steel flat product, having on at least one of its surfaces a baked phosphatic insulation coating, wherein when a thickness D of the phosphatic insulation coating is ≦3 μm, a specific coating density r of the phosphatic insulation coating is ≧5 g/m², and when the thickness is D>3 μm, the following applies for the specific coating density r of the phosphatic insulation coating:
r [g/m²]>3/5 g/μm/m²*D [μm].

14. The grain-oriented electrical steel flat product according to claim 13, wherein when the specific coating density r of the phosphatic insulation coating is ≧5.0 g/m², the following applies for a tensile stress Z transferred by this coating:
Z [MPa]>7/6 MPa*m²/g*r [g/m²].

15. The grain-oriented electrical steel flat product according to claim 13, wherein between the steel substrate and the phosphatic insulation coating a forsterite layer is present.

16. The grain-oriented electrical steel flat product according to claim 14, wherein between the steel substrate and the phosphatic insulation coating a forsterite layer is present.
